(19) United States
(12) Patent Application Publication
(10) Pub. No.: US 2009/0201684 A1
(43) Pub. Date: Aug. 13, 2009

(54) Light Diffuser

(76) Inventor: Patty Helm, Collinsville, OK (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/028,158

(22) Filed: Feb. 8, 2008

(51) Int. Cl. F21V 11/00; F21V 1/06

(52) U.S. Cl. 362/352; 362/355

(57) ABSTRACT

Disclosed is a light diffuser for reducing a glaring effect of a fluorescent light emitted by a fluorescent light source. The fluorescent light source is housed in a light fixture. The fluorescent light passes through an opening in the light fixture. The light diffuser comprises a plastic cover sheet adapted to cover the opening of the light fixture. The plastic cover sheet comprises a shaded pattern and is configured to be translucent for reducing the glaring effect of the fluorescent light emitted by the fluorescent light source.

### FIELD OF THE INVENTION

The present invention relates to light shades, and more particularly to a light diffuser for diffusing fluorescent light emitted by a fluorescent light source.

### BACKGROUND OF THE INVENTION

Bright lighting, such as lighting provided by a fluorescent light source, is typically used for illuminating residential, commercial and industrial areas. The fluorescent light source is typically mounted within a fixture provided at an appropriate location, such as a ceiling of a room, for illumination purposes. A fluorescent light passes through an area of the fixture for illuminating a desired area. A light shade may be provided along with the fluorescent light source for focusing the fluorescent light emitted from the fluorescent light source over the desired area.

The fluorescent light emitted from the area of the fixture may be harsh with regard to the intensity of the fluorescent light and, as such, may cause strain on eyes of those present in vicinity of the fluorescent light. Further, the harsh fluorescent light may reduce productivity of workers in a workplace. Further, the harsh fluorescent light may also adversely affect children suffering from visual impairments such as Scotopic Sensitivity Syndrome.

Typical light shades focus the fluorescent light on the desired area, thereby increasing the intensity of the fluorescent light to produce a glaring effect on users.

Accordingly, there exists a need for diffusing the fluorescent light to reduce the glaring effect of the fluorescent light emitted by the fluorescent light source. Diffusing the fluorescent light may prevent strain on the eyes of the users. Also, reducing the glaring effect of the fluorescent light may result in a relaxing environment conducive for increasing the productivity of the workers at a workplace.

Further, there exists a need for precluding any modification to the fluorescent light source or to the light fixture for diffusing the fluorescent light. Furthermore, there is exists a need for diffusing the fluorescent light while maintaining an aesthetic appeal of the light fixture.

### SUMMARY OF THE INVENTION

An object of the present invention is to provide a light diffuser for reducing a glaring effect of a fluorescent light emitted by a fluorescent light source.

Another object of the present invention is to provide a light diffuser for diffusing the fluorescent light precluding modifications to the fluorescent light source or to a light fixture.

Yet another object of the present invention is to provide a light diffuser for diffusing the fluorescent light and maintain an aesthetic appeal of the light fixture.

In view of the foregoing disadvantages inherent in the prior art, the general purpose of the present invention is to provide a light diffuser configured to include all advantages of the prior art, and to overcome the drawbacks inherent therein. The light diffuser is capable of reducing a glaring effect of a fluorescent light emitted by a fluorescent light source. The fluorescent light source is housed in a light fixture. The fluorescent light passes through an opening in the light fixture. The light diffuser comprises a plastic cover sheet adapted to cover the opening of the light fixture. The plastic cover sheet comprises a shaded pattern and is configured to be translucent for reducing the glaring effect of the fluorescent light emitted by the fluorescent light source.

The light diffuser comprises a coupling mechanism for affixing the plastic cover sheet to the light fixture for covering the opening of the fixture by precluding modifications to the fluorescent light source or to the light fixture. Further, the shaded pattern may be designed to be an artwork selected from a group comprising cartoons, modern arts, designs and photographs for maintaining the aesthetic appeal of the light fixture.

These together with the other aspects of the present invention, along with the various features of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A illustrates a front view of a light diffuser in accordance with an exemplary embodiment of the present invention;

FIG. 1B illustrates a perspective view of an exemplary arrangement of light diffusers affixed on fixtures on a ceiling of a room, in accordance with an embodiment of the present invention;

FIG. 2 illustrates an exemplary shaded pattern on a plastic cover sheet, in accordance with an embodiment of the present invention; and

FIG. 3 illustrates an exemplary environment for affixing light diffusers on fixtures, in accordance with an embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The term “top”, “bottom” and the like, herein do not denote any order, elevation or importance, but rather are used to distinguish placement of one element over another, and the terms “a” and “an” herein do not denote a limitation of quantity, but rather denote the presence of at least one of the referenced item.

The present invention provides a light diffuser for reducing glaring effect of a fluorescent light emitted by a fluorescent light source. The fluorescent light source is housed in a light fixture. The fluorescent light passes through an opening in the light fixture. The light diffuser comprises a plastic cover sheet adapted to cover the opening of the light fixture. The plastic cover sheet comprises a shaded pattern configured to be translucent for reducing the glaring effect of the fluorescent light emitted by the fluorescent light source.

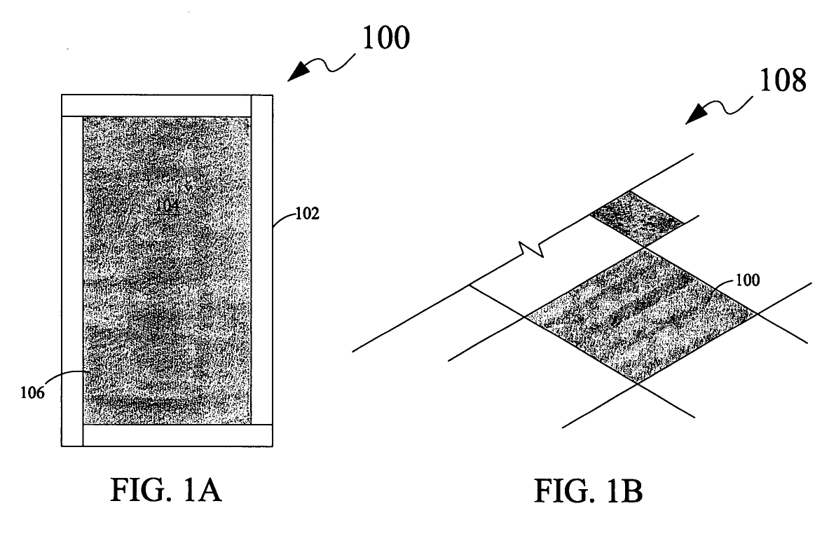

FIG. 1A illustrates a front view of a light diffuser 100 in accordance with an exemplary embodiment of the present invention. The light diffuser 100 includes a plastic cover sheet 102. The plastic cover sheet 102 includes a first surface 104 and a second surface (not shown). The first surface 104 includes a shaded pattern 106 formed thereon. The shaded pattern 106 may either be formed on the first surface 104 or may be embedded within the plastic cover sheet 102. The shaded pattern 106 provides translucency to the plastic cover sheet 102.

The shaded pattern 106 that provides translucency to the plastic cover sheet 102 may be formed by printing, coloring, sketching, pasting, molding, and other similar operations. The shaded pattern 106 may also be an artwork selected at least from one of a cartoon, a modern art, a design and a photograph to maintain an aesthetic appeal of the light fixture. The shaded pattern 106 is configured to tint the first surface 104 of the plastic cover sheet 102 to reduce a glaring effect of a fluorescent light (not shown) passing through the plastic over sheet 102.

The light diffuser 100 may include a coupling mechanism (not shown) on the second surface of the plastic cover sheet 102 for affixing the plastic cover sheet 102 to an opening of a light fixture (not shown). The light fixture houses a fluorescent light source (not shown). The fluorescent light emitted from the fluorescent light source passes through the opening of the light fixture to illuminate a desired area. The glaring effect of the fluorescent light emitted by the fluorescent light source may be reduced by affixing the light diffuser 100 to the opening of the light fixture. The shaded pattern 106 on the plastic cover sheet 102 may reduce the glaring effect of the fluorescent light and provide illumination with reduced intensity.

FIG. 1B illustrates a perspective view of an exemplary arrangement of the light diffuser 100 affixed on a light fixture (not shown) housed in a ceiling 108 of a room (not shown), in accordance with an embodiment of the present invention. It will be evident to those skilled in the art that the light fixture may include a socket for a light source and electrical cabling for supplying electrical power to the light source. In FIG. 1B, the light fixture is housed in a cut-out portion in the ceiling 108 of the room. The fluorescent light source may be housed in the light fixture and may draw electrical power from the electrical cabling for emitting the fluorescent light. The emitted fluorescent light passes through the opening in the light fixture for illuminating a desired area under the ceiling 108. As explained in conjunction with FIG. 1A, the light diffuser 100 may be used to reduce the glaring effect of the fluorescent light emitted from the fluorescent light source. The plastic cover sheet 102 may be adapted to cover the opening of the light fixture. The shaded pattern 106 on the first surface 104 of the plastic cover sheet 102 provides a translucent surface for passage of the fluorescent light, thereby reducing the glaring effect of the fluorescent light.

Further, as explained in conjunction with FIG. 1A, the light diffuser 100 may include the coupling mechanism on the second surface of the plastic cover sheet 102 for affixing the plastic cover sheet 102 to the opening of the light fixture. Examples of the coupling mechanism may include adhesive strips, Velcro arrangement, fastening arrangement, and the like. However, it will be obvious to a person skilled in the art that the coupling mechanism, such as the adhesive strips, the Velcro arrangement and the fastening arrangement may be provided on the first surface 104. In one embodiment of the present invention, the light diffuser 100 is dimensioned to fit the opening of the light fixture. The light fixture may further be designed with protruded edges at the opening. The light diffuser 100 may be placed on the protruded edges to cover the opening of the light fixture, thereby precluding any modification to the fluorescent light source or the light fixture. Further, the plastic cover sheet 102 may be composed of a flexible material facilitating placing of the light diffuser 100 onto light fixtures of different shapes.

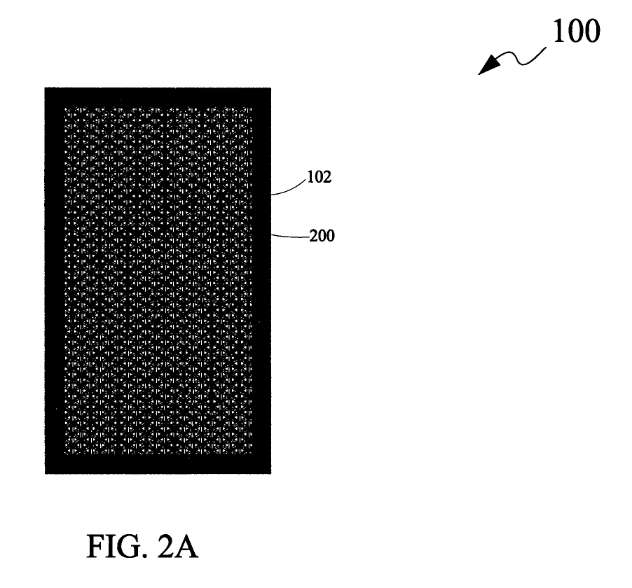

FIG. 2 illustrates an exemplary shaded pattern 202 on the plastic cover sheet 102, in accordance with an embodiment of the present invention. It will be evident to those skilled in the art that the shaded pattern 202 is shown for exemplary purposes only. As explained in conjunction with FIG. 1A, the shaded pattern 202 may include artwork, such as scenic imagery, cartoons, portrait sketches, and other similar artworks, to maintain the aesthetic appeal of the light fixture.

Further, a shaded pattern, such as the shaded pattern 200, may either be embedded in the plastic cover sheet 102 or added by a user of the light diffuser 100. The user may design the shaded pattern to emit a chosen hue. It will be evident to those skilled in the art that the shaded pattern may be chosen of any shape and size for tinting the first surface 104 of the plastic cover sheet 102.

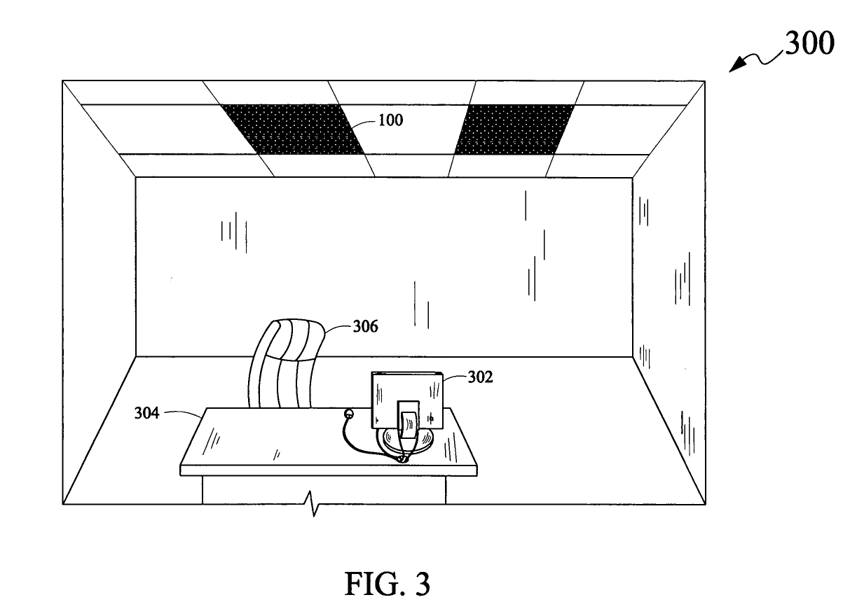

FIG. 3 illustrates an exemplary environment 300 for affixing light diffusers, such as the light diffuser 100 on fixtures, in accordance with an embodiment of the present invention. The exemplary environment 300 depicts a typical workplace with a data processing device 302 placed on a table 304 and a seating arrangement 306. The typical workplace is illuminated by fluorescent light sources (not shown) housed in light fixtures in cut-outs in a ceiling of the typical workplace. Fluorescent light emitted from the fluorescent light sources is directed towards the table 304 for illuminating a working area configured by the data processing device 302, the table 304 and the seating arrangement 306. A glaring effect of the fluorescent light emitted from the fluorescent light sources is reduced by placing the light diffusers on an opening of the light fixtures housing the fluorescent light sources. The shaded pattern 106 of the light diffuser 100 filter the fluorescent light passing through the plastic cover sheet 102, thereby reducing the glaring effect of the fluorescent light and filling the typical workplace with a hue of reduced intensity.

It will be evident to those skilled in the art that the light diffusers, such as the light diffuser 100, may be used in environments similar to the exemplary environment 300 such as classrooms, office environments, homes, and the like. A light diffuser, such as the light diffuser 100, reduces the glaring effect of the fluorescent light, thereby reducing strain on the eyes of users. Reduced eye-strain may also increase productivity of the users at a workplace. Further, the light diffuser may also benefit children suffering from visual impairments such as Scotopic Sensitivity Syndrome.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A light diffuser for reducing a glaring effect of a fluorescent light emitted by a fluorescent light source, the fluorescent light source housed in a light fixture, the fluorescent light passing through an opening in the light fixture, the light diffuser comprising:
a plastic cover sheet comprising a shaded pattern, the plastic cover sheet configured to be translucent for reducing the glaring effect of the fluorescent light emitted by the fluorescent light source,
wherein the plastic cover sheet is adapted to cover the opening of the light fixture.

2. The light diffuser of claim 1, further comprising a coupling mechanism for affixing the plastic cover sheet to the light fixture for covering the opening of the light fixture.

3. The light diffuser of claim 1, wherein the plastic cover sheet further comprises adhesive strips capable of affixing the plastic cover sheet to the light fixture for covering the opening of the light fixture.

4. The light diffuser of claim 1, wherein the shaded pattern is configured to tint a first surface of the plastic cover sheet.

5. The light diffuser of claim 1, wherein the shaded pattern is formed on the plastic cover sheet by at least one of molding, sketching, coloring, pasting and printing.

6. The light diffuser of claim 1, wherein the shaded pattern is embedded within the plastic cover sheet.

7. The light diffuser of claim 1, wherein the shaded pattern is an artwork selected from at least one of cartoons, modern art, designs and photographs.

8. The light diffuser of claim 1, wherein the plastic cover sheet is flexible.
